(19) United States
(12) Patent Application Publication
(10) Pub. No.: US 2023/0169494 A1
(43) Pub. Date: Jun. 1, 2023

(54) SYSTEM AND METHOD FOR APPLICATION OF SMART RULES TO DATA TRANSACTIONS

(71) Applicant: CURVE OS LIMITED, London (GB)

(72) Inventors: Shachar BIALICK, London (GB); Adrian McMICHAEL, London (GB); Cheonhyun PARK, Brookyln, NY (US); Daniel POSWOLSKY, New York, NY (US)

(73) Assignee: CURVE OS LIMITED, London (GB)

(21) Appl. No.: 17/539,245

(22) Filed: Dec. 1, 2021

(51) Int. Cl. G06Q 20/38; G06N 5/04

(52) U.S. Cl. CPC G06Q 20/38; G06N 5/04

(57) ABSTRACT

A computer-implemented method of exchanging data is provided. Before a transaction, the transaction including exchange of data: associating a plurality of funding sources with an account; defining one or more rules, each corresponding to a condition and a specified funding source from the plurality; assigning a priority to each rule; and storing rules and priorities associated with the account. At a time of a transaction: receiving data describing the transaction; determining if the transaction satisfies any condition of the rules, the funding source from the satisfied rule being the determined funding source unless more than one rule has a satisfied condition. In the event of more than one rule with a satisfied condition, the highest priority rule among all satisfied conditions determines the funding source to be charged. In the event of determining that no condition is satisfied, charging any one of the plurality of associated funding sources.

### FIELD OF THE INVENTION

The present application is in the field of rule-based selection and rule processing.

### BACKGROUND OF THE INVENTION

In general, when a transaction is made, an underlying funding source funds the transaction, be that cash, credit/debit card, or electronic wallet (e.g. PayPal, crypto currency). Ordinarily, there is conscious consideration on the part of a human consumer as to which funding source to use for a given transaction. For example, groceries may be paid for with a debit card, whilst business expenses (e.g. taxi, airfare, hotel) may be paid for with a business credit card. In each case the consumer ordinarily chooses the appropriate funding source for the type of transaction. As more and more funding sources become accessible to consumers (e.g. multiple credit cards) there is a burden placed upon the consumer to recall the suitability of a given funding source for a particular transaction. For example, each credit card available to the consumer has an associated credit limit, interest rate, potential cashback promotion etc., all of which might influence one credit card as being more suitable for a particular transaction than another credit card. There is also a greater trend towards contactless payment methods such as through the near field communication (NFC) capability of modern day smartphones (e.g. the Apple Pay, Google Pay, Samsung Pay systems) for which a physical card is not required to be present. It would therefore be desirable to be able to pay for all transactions with one payment instrument and assign the transaction to a given underlying funding source of multiple associated funding sources.

### SUMMARY OF THE INVENTION

According to an embodiment of the present invention there is thus provided a computer-implemented method of exchanging data, the method comprising the steps of: prior to a transaction, the transaction comprising an exchange of data: associating a plurality of funding sources with an account; defining one or more rules, each rule corresponding to a condition and a specified funding source from the plurality of associated funding sources; assigning a priority to each of the one or more rules; storing the one or more rules and the priorities against the account; and, at a time of a transaction; receiving data describing the transaction; determining if the transaction satisfies any condition of the one or more rules, the funding source from the satisfied rule being the determined funding source unless more than one rule has a satisfied condition; wherein, in the event of more than one rule with a satisfied condition, the highest priority rule among all satisfied conditions determines the funding source to be charged; and charging the determined funding source, wherein, in the event of determining that no condition is satisfied, charging any one of the plurality of associated funding sources.

According to some embodiments, the step of determining if the transaction satisfies any condition of the one or more rules is performed using an Open Policy Agent.

According to some embodiments, the step of determining if the transaction satisfies any condition of the one or more rules is performed for all rules in parallel.

According to some embodiments, the step of determining if the transaction satisfies any condition of the one or more rules is performed in a non-procedural manner.

According to some embodiments, the received data of the transaction includes at least one of: a time of the transaction; a merchant identification (ID); a category of merchant; a value of the transaction; a currency of the transaction; and/or a geographic location of the transaction

According to some embodiments, at least one defined rule is a default rule corresponding to a specified funding source to be used in the event that no condition of any other rule is satisfied by a transaction.

According to some embodiments, the method further includes: after one or more transactions: deducing, by machine learning, one or more transaction behaviors; and recommending one or more rules based on the one or more deduced transaction behaviors.

According to an embodiment of the invention there is provided a system comprising: a memory; and a processor configured to: prior to any transaction: store, in a database, details of an account; associate a plurality of funding sources with the account; define one or more rules, each rule corresponding to both a condition and a specified funding source from the plurality of associated funding sources; assign a priority to each of the one or more rules; store, in the database, the one or more rules and priorities associated with the account; and, at a time of a transaction; receive data of the transaction; determine if the transaction satisfies any condition of the one or more rules, wherein, in the event of more than one satisfied condition, the highest priority rule among all satisfied conditions determines the funding source to be charged; and, charge the determined funding source, wherein, in the event of determining that no condition is satisfied, charge any one of the plurality of associated funding sources.

According to some embodiments, the processor is configured to execute an Open Policy Agent to determine if the transaction satisfies any condition of the one or more rules.

According to some embodiments, the processor is configured to determine if the transaction satisfies any condition of the one or more rules for all rules in parallel.

According to some embodiments, the processor is configured to determine if the transaction satisfies any condition of the one or more rules in a non-procedural manner.

According to some embodiments, the received data of the transaction comprises at least one of: a time of the transaction; a merchant ID; a category of merchant; a value of the transaction; a currency of the transaction; and a geographic location of the transaction.

According to some embodiments, at least one defined rule is a default rule corresponding to a specified funding source to be used in the event that no condition of any other rule is satisfied by a transaction.

According to some embodiments, the processor is configured to: after one or more transactions: deduce, by executing an artificial intelligence, one or more transaction behaviors; and recommend one or more rules based on the one or more deduced transaction behaviors.

According to an embodiment of the invention there is provided a computer-implemented method of exchanging data tokens, the method comprising the steps of: prior to a transfer of data tokens: associating a plurality of token sources with an account; defining one or more rules, each rule corresponding to a condition and a specified token source from the plurality of associated token sources; assigning a priority to each of the one or more rules; storing the one or more rules and the priorities against the account; and, at a time of a transfer of data tokens; receiving data describing the transfer; determining if the transfer satisfies any condition of the one or more rules, the token source from the satisfied rule being the determined token source unless more than one rule has a satisfied condition; wherein, in the event of more than one rule with a satisfied condition, the highest priority rule among all satisfied conditions determines the token source to be used; and using the determined token source, wherein, in the event of determining that no condition is satisfied, using any one of the plurality of associated token sources.

According to some embodiments, determining if the transfer of data tokens satisfies any condition of the one or more rules may be performed using an Open Policy Agent.

According to some embodiments, determining if the transfer satisfies any condition of the one or more rules may be performed in a non-procedural manner.

According to some embodiments, the received data of the transfer may comprise at least one of: a time of said transfer; a recipient ID; a number of data tokens; a type of data tokens; and a geographic location of said transfer.

According to some embodiments, at least one defined rule may be a default rule corresponding to a specified token source to be used in the event that no condition of any other rule is satisfied by a transfer.

According to some embodiments, after one or more transfers, an artificial intelligence may deduce one or more transfer behaviors, and may recommend one or more rules based on the one or more deduced transfer behaviors.

### BRIEF DESCRIPTION OF THE FIGURES

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a high-level block diagram of an exemplary computing device according to some embodiments of the present invention; and

FIG. 2 is a high level diagram of a process flow, according to some embodiments of the invention.

FIG. 3 is a flowchart of a method, according to some embodiments of the present invention.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Embodiments of the present invention provide a method for assigning a transaction to one of a plurality of funding sources according to predetermined criteria and/or rules. Embodiments of the invention are also directed towards exchanging data, the data exchanged (particularly the data sent by embodiments of the invention) being in accordance with predetermined criteria and/or rules. In this way, embodiments of the invention may provide improvements to the technology of rule-based selection of data. A transaction, e.g. a financial transaction, may involve an exchange of data.

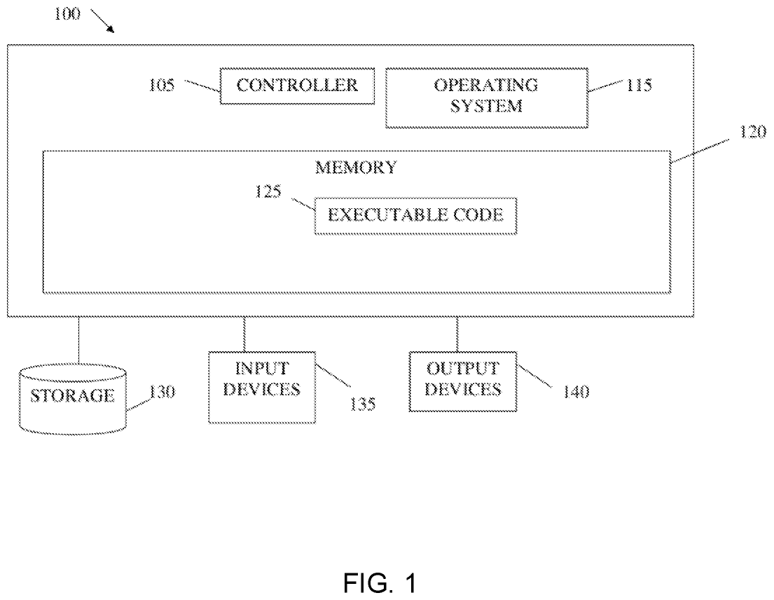

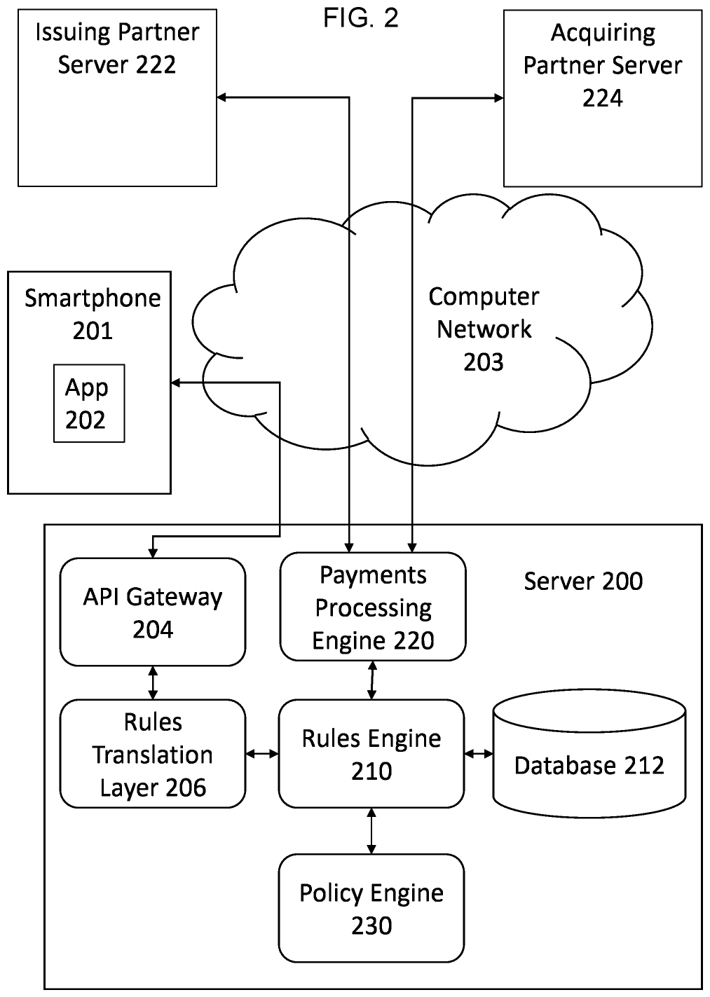

Reference is made to FIG. 1, showing a high-level block diagram of an exemplary computing device according to some embodiments of the present invention. Computing device 100 may include: a controller 105 that may be, for example, a central processing unit processor (CPU) or any other suitable multi-purpose or specific processors or controllers, a chip or any suitable computing or computational device; an operating system 115; a memory 120; executable code 125; a storage system 130; input devices 135; and output devices 140. Controller 105 (or one or more controllers or processors, possibly across multiple units or devices) may be configured to carry out methods described herein, and/or to execute or act as the various modules, units, engines, etc. for example when executing code 125. More than one computing device 100 may be included in, and one or more computing devices 100 may be, or act as the components of, a system according to embodiments of the invention. Various components, computers, and modules of FIG. 2 may be or include devices such as computing device 100.

Operating system 115 may be or may include any code segment (e.g., one similar to executable code 125) designed and/or configured to perform tasks involving coordination, scheduling, arbitration, controlling or otherwise managing operation of computing device 100, for example, scheduling execution of software programs or enabling software programs or other modules or units to communicate.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory or storage units. Memory 120 may be, or may include, a plurality of possibly different memory units. Memory 120 may be a computer or processor non-transitory readable medium, or a computer non-transitory storage medium, e.g., a RAM.

Executable code 125 may be any executable code, e.g., an application, a program, a process, task, or script. Executable code 125 may be executed by controller 105 possibly under control of operating system 115. Although, for the sake of clarity, a single item of executable code 125 is shown in FIG. 1, a system according to some embodiments of the invention may include a plurality of executable code segments similar to executable code 125 that may be loaded into memory 120 or another non-transitory storage medium and cause controller 105, when executing code 125, to carry out methods described herein.

Storage system 130 may be or may include, for example, a hard disk drive, a CD-Recordable (CD-R) drive, a Blu-ray disk (BD), a universal serial bus (USB) device or other suitable removable and/or fixed storage unit. Some of the components shown in FIG. 1 may be omitted. For example, memory 120 may be a non-volatile memory having the storage capacity of storage system 130. Accordingly, although shown as a separate component, storage system 130 may be embedded or included in memory 120.

Input devices 135 may be or may include a mouse, a keyboard, a microphone, a touch screen or pad or any suitable input device. Any suitable number of input devices may be operatively connected to computing device 100 as shown by block 135. Output devices 140 may include one or more displays or monitors, speakers and/or any other suitable output devices. Any suitable number of output devices may be operatively connected to computing device 100 as shown by block 140. Any applicable input/output (I/O) devices may be connected to computing device 100 as shown by blocks 135 and 140. For example, a wired or wireless network interface card (MC), a printer, a universal serial bus (USB) device or external hard drive may be included in input devices 135 and/or output devices 140.

In some embodiments, device 100 may include or may be, for example, a mobile phone, a personal computer, a desktop computer, a laptop computer, a workstation, a server computer, a network device, or any other suitable computing device. A system as described herein may include one or more devices such as computing device 100.

According to a broad aspect of the invention there is provided a computer implemented method of charging one of a plurality of funding sources. The computer implementation may use one or more computing devices as described above with reference to FIG. 1.

As used herein, the term “funding source” may refer to a system for funding a transaction, and to the data associated with or describing that funding source. For example a funding source may be data describing, but not limited to: bank account with linked debit card, credit card, electronic wallet (e.g. crypto currency), and/or promotional/reward/loyalty points (e.g. air miles, Nectar points). A transaction may be an exchange of data across a computer network, for example computer network 203 as shown in FIG. 2. For example, each of a number of entities (e.g. a merchant or merchant site, acquiring partner, issuing partner, transaction processing engine, etc., as shown in FIG. 2) may operate computers or servers, which may conduct a transaction. The transaction may be an exchange of data among the various entities which corresponds to for example, an exchange of funds, a sale, an exchange of goods and services, or a data access request (whereby a request for a user record may be granted, partially granted, or denied depending on the requesting user, and different levels of information may be returned as a result. A customer service agent may place flags/rules on a user for aberrant behavior, whereas the user themselves may not see these flags in the data exchange). A transaction may also refer to the set of data exchanged or describing the transaction.

Prior to any transaction, for example in a “registration stage”, details of an account may be stored in a database, for example a financial database. The details may include, for example, name, age, home address, telephone number, email address and/or any other details sufficient to identify and/or verify the identity of the account holder. The database may generate and/or store a unique account holder ID associated with the account.

The registration stage may further include associating a plurality of funding sources with the account. For example, the account holder may register details of a debit and/or credit card such as issuing bank, card number, sort code, International Bank Account Number (IBAN) and the like. The account holder may register a first debit card, a second debit card etc. Similarly the account holder may register a first credit card, a second credit card etc. The account holder may provide details of an electronic wallet.

In some embodiments a single payment instrument may be issued to the account holder which links to the associated underlying funding sources.

With reference to FIG. 2, and according to some embodiments, in a “rules setup stage” prior to a transaction, the account holder may interactively (e.g. in response to prompts/recommendations and/or by toggling settings, drop down lists, sliders etc.) define one or more rules which govern the assignment of a funding source to a particular transaction through a dedicated user interface which is part of an application/app 202 executing on a smartphone 201 or other device. Such a device may be a computing device 100 as shown in FIG. 1. The user inputs may be transformed into calls to an application programming interface (API) gateway 204 (transferred across computer network 203) executed on a server 200. The API gateway 204 may in turn pass the user inputs to a rule translation layer 206 executed on server 200. The rule translation layer 206 may produce a rules document on the basis of the user inputs. The rules document may be, for example, a JSON (JavaScript Object Notation) document. The rules document may then be saved against the account holder's ID via a call to a rules engine 210 executed on server 200 which saves the rules document to its data-store, for example, a database 212 stored on server 200.

Each defined rule may correspond to, or be associated with, a condition and a specified funding source from the plurality of funding sources. The condition part of a rule may be any logical criterion/criteria that is/are separate from the identification of the funding source. According to some embodiments a condition may be, for example: a time of said transaction; a merchant ID; a merchant category code; a value of said transaction; a currency of said transaction; a currency conversion rate; a geographic location of said transaction; a minimum balance requirement; a daily transaction allowance; a current stock/share price of a particular stock/share; an overdraft limit; a credit limit; and/or an interest rate. For example, for the rule “For groceries, charge credit card 1”, the condition part is “For groceries”. The conditions in a rule may have to match or satisfy external real-world facts in order for the rule to be executed, for there to be a positive match for the rule, e.g. for the rule to determine a funding source. In the example rule “For groceries, charge credit card 1” the condition “For groceries” may have to be matched against a received merchant category code (e.g. 5411 for grocery stores) received as part of transaction data, in order to evaluate if the condition is satisfied. As another example, the time condition may have to match the real-world time for there to be a rule match or satisfaction. Data received at a time of transaction may contain such facts useful in determining a satisfied condition of a rule.

A non-limiting example rule set may act as follows: “For groceries, charge credit card 1”; “For taxis between the times of 09:00 and 17:00 Monday to Friday, charge business expenses card”; “Whilst debit card 2 has a balance greater than $1000, charge debit card 2”. In such a manner the “action” or second part of the rule may be a funding source (e.g. debit card, credit card, etc.) and a rule may be associated with or correspond to a funding source. Multiple rules with different conditions may be defined for the same funding source. An example representation of a rule for weekday taxis between the times of 09:00-17:00 less than $100 is shown below:

```
{
  “id”: “bef408b7-0ab8-4575-97af-c556b7f77f3f”,
  “displayName”: “Travel for Business”,
  “category”: “custom”,
  “accountID”: “bf373e4d-48e4-4ac3-a5ce-d32063027776”,
  “enabled”: true,
  “deleted”: false,
  “fundingSourceIDs”: [“4e0daa13-b178-4214-b00f-76f7d4e0c4cb”],
  “timeRules”: “0 0 9-17 ? * MON-FRI *”,
  “merchantCategoryCodes”: [“4121”],
  “amountLimits”: [
  {
    “amount”: 10000,
    “function”: “lte”
  }
  ],
  “currency”: “USD”,
  “priority”: 100
}
```

The “rules setup stage” may allow an account holder to interactively assign a priority (e.g. by receiving input from the user, for example by screen-based toggles, sliders etc.) to each of the defined rules. The priority may be a numerical ranking, e.g. a priority of “1” is a higher priority than a priority of “2” which is higher than a priority of “3” etc. Alternatively, as may be more practicable, a higher numeric ranking may indicate a higher priority (e.g. 10 is a higher priority than 5, which is a higher priority than 1) so as to enable new rules to be given higher priorities above existing rules without the need to reassign the priorities of the existing lower ranked rules. Assigning a priority may have the effect that when a transaction satisfies more than one condition for more than one funding source, one of those funding sources takes priority and is charged for the transaction. For example in determining if a transaction satisfies any condition of the one or more rules, the funding source from the satisfied rule may be the determined funding source unless more than one rule has a satisfied condition. In the event of more than one rule with a satisfied condition, the highest priority rule among all satisfied conditions may determine the funding source to be charged. Rules and their assigned priorities may be stored together in the database 212 as part of the same rules document.

At a time of transaction, a payments processing engine 220 executed on server 200 may receive a transaction for processing from an issuing partner server 222 over computer network 203. The issuing partner server 222 may be, for example, operated by an issuer of the single payment instrument linked to the user's account and plurality of funding sources. The payments processing engine 220 may receive data associated with or describing the transaction/data exchange which may provide a context of said transaction. According to some embodiments the received transaction data includes at least one of: user account ID; a time of said transaction; a merchant ID; a merchant category code; a value of said transaction; a currency of said transaction; and/or a geographic location of said transaction. The received data may include external real-world facts useful in evaluating if a condition of a rule is satisfied. For example, data indicating a transaction in pounds sterling (£) may be used in evaluating a rule such as “For purchases in a currency other than US dollars ($), use the funding source with the best currency conversion rate for that currency”.

The payments processing engine 220 may query the rules engine 210 as to which funding source to use by providing the user account ID and transaction data for the transaction in progress. The rules engine 210 may pre-process the transaction data to make it suitable for use with a policy engine 230 executed on server 200 and may enrich the transaction data with data from one or more enrichment sources. The rules engine 210 may loop for every such enrichment source in parallel.

For example, one enrichment source may be a foreign exchange (FX) rates service, and the rules engine 210 may ask for current FX rates for the transaction currency into the user's localized currency. The FX rates service may return the FX rates. The rules engine 210 may convert the transaction amount to localized currency based on the FX rates (e.g. convert a foreign transaction in Euros (€) into the user's local currency of US dollars ($)) and add this to the enrichment information.

As another example, one enrichment source may be a categorizer, and the rules engine 210 may ask for the user's spending category for the transaction. The categorizer may use transaction attributes such as merchant category code to bind the transaction to one of a set of user spending categories e.g., Eating Out, Shopping, etc. The categorizer may return a category. The rules engine 210 may add the spending category to the enrichment information.

As another example, one enrichment source may be a balances service, and rules engine 210 may request balances for current funding sources. The balances service may return the balances. The rules engine 210 may add the balances to the enrichment information.

Thus, one or enrichment sources may return one or more enriched data elements. The rules engine 210 may combine enriched data elements into the transaction data.

The rules engine 210 may then load up the account holder's rules document from the database 212 and pass the pre-processed transaction data and the rules document along to a policy engine 230. The policy engine 230 may be, for example, an Open Policy Agent (OPA) engine, and may use policies stored as .rego files. An OPA engine may analyze rules and construct a “trie”, a tree data structure used for locating specific keys from within a set, and which may allow the OPA engine to find the minimal set of applicable rules. This may allow inapplicable rules to be excluded before evaluation and for the trie to be smartly traversed. An OPA engine may also employ partial evaluation of rules to compile a policy from one layer to a lower layer to translate linear-time policy evaluation into a constant-time policy.

The rules engine 210 may also provide the policy engine 230 with static data, stored, for example, in a JSON document. The static data may include rule relevant data that is invariant from transaction to transaction. For example, the static data may include certain funding source types that are not permitted for certain transaction types, e.g. a loyalty/reward points funding source may not be eligible for a transaction pertaining to a cash withdrawal, and so the static data may indicate that such funding sources are not eligible for such transactions (e.g. transactions with merchant category code 6010 or 6011 pertaining to manual cash disbursements).

The policy engine 230 may use a stored policy (stored, for example, as one or more .rego files) to evaluate the rules document in light of the transaction data and static data and may determine which conditions of which rules are satisfied.

The policy engine 230 may check rules in a non-procedural manner, for example, the policy engine may check each rule in parallel, for example using a trie, rather than checking each rule one after the other.

In the event more than one condition is satisfied for more than one funding source, the highest priority rule among all satisfied conditions determines the funding source to be charged. According to some embodiments, multiple satisfied conditions giving rise to multiple eligible funding sources for the transaction may be ranked according to the assigned priorities such that if the funding source associated with the highest priority rule is declined then the next highest ranked funding source may be used instead, and so on.

For example, for the ruleset [For groceries, charge credit card 1, Priority 1], [For online purchases, charge e-wallet, Priority 2] in the instance of an online purchase of groceries, the rules engine may receive transaction data indicative of both a grocery related transaction and an online related transaction. Accordingly, the rules engine 210, working with the policy engine 230, may determine that conditions of two different rules with different funding sources are satisfied. The rules engine may then determine, on the basis of the assigned priorities, that credit card 1 should be charged because this funding source corresponds to the highest priority rule associated with a satisfied condition among all other satisfied conditions and their associated rules. The payment processing engine 220 may then charge credit card 1 for the online grocery transaction, rather than the e-wallet. If credit card 1 is declined, then the e-wallet may be charged instead, because the e-wallet has been determined to be an “acceptable” funding source for the context of this transaction in accordance with the defined rules.

If a transaction is such that the received transaction data does not satisfy any condition of any rule, the rules engine 210 may select any one of the funding sources associated with the account to be charged. In some embodiments, the rules engine 210 may maintain a “default” rule such that if no condition of any defined rule is satisfied, a “default” funding source is charged.

The “rules setup stage” may be repeated/updated at any time, adjusting conditions and/or funding sources as necessary. In some embodiments, rules may be presented to a user from a pre-selected list of options. In some embodiments, rules may be selected and/or changed via sliders, toggles, drop-down lists or the like.

In some embodiments, a predefined rule may be selectable or may be provided as standard that seeks to maximize acceptance of credit/debit cards. Such a rule may be referred to hereinafter as a “best endeavors routing rule”. The best endeavors routing rule may be responsive to scenarios such as network outages. For example, if the Visa network is experiencing processing issues, such that there is an increased decline rate for Visa cards, the best endeavors routing rule may reroute transactions being paid for by a Visa card to an alternative associated funding source, for example a Mastercard associated with the account.

According to some embodiments, after one or more transactions, artificial intelligence (AI) methods may be used in order to infer or deduce one or more transaction behaviors. On the basis of these deduced transaction behaviors one or more rules may be recommended to a user. AI methods may include machine learning and/or one or more neural networks. AI methods may be implemented in a server, for example server 200. AI methods may include one or more of: correlation algorithms, clustering algorithms, statistical learning, statistical methods, linear regression, classification, resampling methods, linear model selection and regularization, polynomial regression, step functions, basis functions, regression splines, smoothing splines, local regression, tree-based methods, support vector machines, unsupervised learning, supervised learning, neural networks, fuzzy logic, Bayesian statistics, methods, and/or classifiers, and/or any other algorithm and/or mathematical function. An AI model or process may receive transaction data in a vector representation. The AI model or process may analyze data from other users, for example to see if user A and user B have similar transaction behaviors. If user A has a similar transaction behavior to user B (measured, for example, using a similarity measure between vector representations e.g. cosine similarity) then the AI model or process may suggest to user B the rule conditions which user A is using for similar purposes. Similarly, the AI model or process may suggest to user A the rule conditions which user B is using, due to the similar transaction behaviors between users A and B.

According to some embodiments, upon determining a funding source to be used, the rules engine 210 may deliver a selection context or other rationale explaining why the funding source was determined. For example, the account holder may receive a notification that credit card 1 was selected for the most recent transaction, because the account holder had previously defined a rule for credit card 1 which this most recent transaction satisfies. According to some embodiments, the account holder may be asked to confirm the determined funding source before said funding source is charged. Alternatively, the payments processing engine 220 may automatically use the funding source having the highest rank in the returned list.

The payments processing engine 220 may send transaction details with card details to the issuing partner server 222 to make the transaction with the gateway to the user's funding institution. If the issuing partner server 222 accepts the payment, the payments processing engine 220 may return an approval to the payer of the payment to the acquiring partner server 224.

Alternatively, if the issuing partner server 222 rejects the payment, it may return a payment rejection with a reason. The payments processing engine 220 may check the total time so far of the transaction. If there is time to try another funding source, the payments processing engine 220 may select the first funding source from the returned list which has a selection context marking it as a backup (e.g. the next ranked, or a lower ranked funding source). Using this funding source, the payments processing engine 220 may send transaction details with card details to the issuing partner server 222 to make the transaction with the gateway to the user's funding institution. If the issuing partner server 222 rejects the payment, the payments processing engine 220 may return a decline with a reason to the payer. If the issuing partner server 222 accepts the payment, the payments processing engine 220 may return an approval to the payer of the payment to the acquiring partner server 224.

If there is no time to try another funding source, the payments processing engine 220 may return a decline with a reason to the payer.

Embodiments of the invention may improve the time taken to complete end-to-end transfer of data, for example to complete a transaction, because rules are checked in a non-procedural manner (e.g. using a trie to evaluate rules). Embodiments may improve computerized rule processing. Contrasted with alternative methods based on an implementation of business logic through manual IF statements, checked one after the other, embodiments of the present invention provide a more efficient and timely processing of a rule and/or selection of a funding source. This is of particular importance in transactions which rely on a broker or “third party” to facilitate the transaction. What may ordinarily constitute a window for a return transfer of data may also be required to encompass two consecutive return transfers of data, e.g. two back-to-back transactions. For example, when dealing with e-currency, data may be sent to a broker requesting funds. The broker may send data to negotiate and purchase the e-currency. The broker may then send data back to the user who initiated the request. In such an example there are two return transfers of data, one between the user and the broker and the other between the broker and the currency issuer (e.g. a bank). Both data transfers may be constrained to fit in the window of a single data transfer, e.g. a network-imposed timeout. In contexts where the transfer of data relates to financial transactions, additional steps may consume time allotted for the transfer of the data packet, for example fraud checks.

Prior art methods based on policy control are usually directed to access control, for example granting Alice access to a server based on her credentials but refusing access to Bob based on his credentials. Embodiments of the present invention leverage this kind of policy control in a novel way for efficient funding source selection which is also highly adaptive and customizable.

Embodiments of the invention also improve rule processing and invert the concept of a traditional data store and logic by representing the logic for each rule as a policy document and running data through the policy document at runtime. This is in contrast to existing methods of applying logic to a data document. In a traditional service, the logic of the code defines the order in which rules are evaluated and queries are traditionally run against a database to fetch data that matches the search criteria. In some embodiments of the invention (e.g. in an OPA engine) instead of running many queries or one large, complex query, the policy rules themselves have the data passed through them which whittles down the possible matches using an optimal path based on the values of the data passed in using an optimized search tree. It also allows for policy definitions that can be human-read and understood at a glance instead of a series of code files and query builders that may require additional logging to understand.

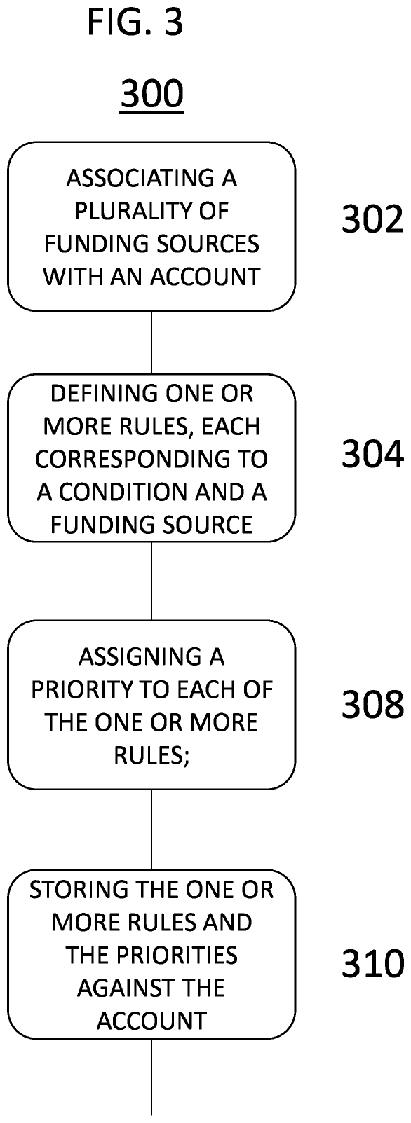

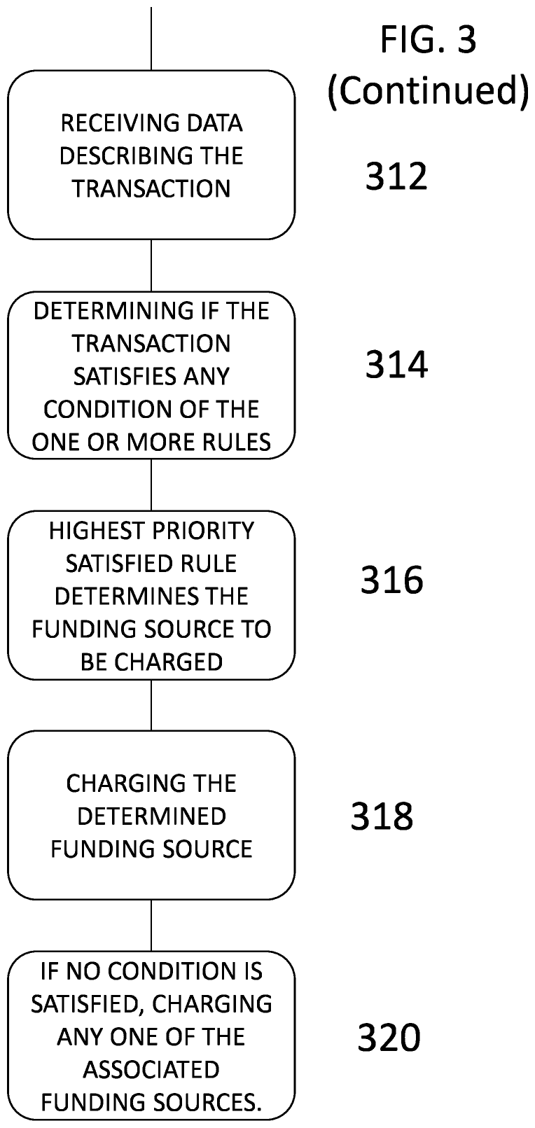

With reference to FIG. 3, according to some embodiments of the invention there is provided a computer-implemented method (implemented, for example, on a computing device such as shown in FIG. 1) for exchanging data (e.g. for charging one of a plurality of funding sources). According to some embodiments there is provided a computer-implemented method 300 (implemented, for example, on a computing device such as shown in FIG. 1) of exchanging data, wherein a transfer includes an exchange of data.

A method 300 may include, prior to a transaction, the transaction including an exchange of data, associating 302 a plurality of funding sources with an account; defining 304 one or more rules, each rule corresponding to a condition and a specified funding source from the plurality of associated funding sources; assigning 308 a priority to each of the one or more rules; and storing 310 the one or more rules and the priorities against the account.

A method 300 may include, at a time of a transaction, receiving 312 data describing the transaction and determining 314 if the transaction satisfies any condition of the one or more rules, the funding source from the satisfied rule being the determined funding source unless more than one rule has a satisfied condition.

In the event of more than one rule with a satisfied condition, the highest priority rule among all satisfied conditions determines 316 the funding source to be charged.

Method 300 may involve charging 318 the determined funding source. In the event of determining that no condition is satisfied, method 300 may charge 320 any one of the plurality of associated funding sources.

Similarly, according to some embodiments of the invention, there is provided a computer-implemented method of exchanging data tokens, the method including, prior to a transfer of data tokens: associating a plurality of token sources with an account; defining one or more rules, each rule corresponding to a condition and a specified token source from the plurality of associated token sources; assigning a priority to each of the one or more rules; storing the one or more rules and the priorities against the account; and, at a time of a transfer of data tokens; receiving data describing the transfer; determining if the transfer satisfies any condition of the one or more rules, the token source from the satisfied rule being the determined token source unless more than one rule has a satisfied condition; wherein, in the event of more than one rule with a satisfied condition, the highest priority rule among all satisfied conditions determines the token source to be used; and using the determined token source, wherein, in the event of determining that no condition is satisfied, using any one of the plurality of associated token sources.

A data token may be a packet of data. A data token my represent a fixed size, or quantum, of data. A token source may be a represent a store/collection of data tokens.

According to an embodiment, determining if the transfer of data tokens satisfies any condition of the one or more rules may be performed using an Open Policy Agent. According to an embodiment, determining if the transfer satisfies any condition of the one or more rules may be performed in a non-procedural manner, for example, for all rules in parallel.

In some embodiments, the received data of the transfer may comprise at least one of: a time of said transfer; a recipient ID (e.g. an identification of the entity receiving data tokens); a number of data tokens (e.g. 100 data tokens, 5 data tokens); a type of data tokens (e.g. of a first type, second type, etc.); and a geographic location of said transfer.

In some embodiments, at least one defined rule may be a default rule corresponding to a specified token source to be used in the event that no condition of any other rule is satisfied by a transfer.

In some embodiments, after one or more transfers, an artificial intelligence may deduce one or more transfer behaviors, and may recommend one or more rules based on the one or more deduced transfer behaviors.

As will be appreciated by one skilled in the art, aspects of the present invention may be embodied as a system, method, or computer program product. Accordingly, some aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in base band or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing. Computer program code for carrying out operations for aspects of the present invention may be written in any combination of one or more programming languages, including an object-oriented programming language such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Some aspects of the present invention are described above with reference to flowchart illustrations and/or portion diagrams of methods, apparatus (systems) and computer program products according to some embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram portion or portions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram portion or portions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions.

The aforementioned flowchart and diagrams illustrate the architecture, functionality, and operation of possible implementations of systems, methods, and computer program products according to various embodiments of the present invention. In this regard, each portion in the flowchart or portion diagrams may represent a module, segment, or portion of code, which includes one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only. The principles and uses of the teachings of the present invention may be better understood with reference to the accompanying description, figures, and examples.

It is to be understood that the details set forth herein do not construe a limitation to an application of the invention. Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps, or integers. If the specification or claims refer to “an additional” element, that does not preclude there being more than one of the additional element. It is to be understood that, where the claims or specification refer to “a” or “an” element, such reference is not to be construed that there is only one of that element. It is to be understood that where the specification states that a component, feature, structure, or characteristic “may”, “might”, “can” or “could” be included, that particular component, feature, structure, or characteristic is not required to be included. Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described. Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only. Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein. Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A computer-implemented method of exchanging data, the method comprising the steps of:
prior to a transaction, the transaction comprising an exchange of data:
associating a plurality of funding sources with an account;
defining one or more rules, each rule corresponding to a condition and a specified funding source from the plurality of associated funding sources;
assigning a priority to each of the one or more rules;
storing the one or more rules and the priorities against the account;
and,
at a time of a transaction;
receiving data describing the transaction;
determining if the transaction satisfies any condition of the one or more rules, the funding source from the satisfied rule being the determined funding source unless more than one rule has a satisfied condition;
wherein, in the event of more than one rule with a satisfied condition, the highest priority rule among all satisfied conditions determines the funding source to be charged; and
charging the determined funding source,
wherein, in the event of determining that no condition is satisfied, charging any one of the plurality of associated funding sources.

2. The method of claim 1, wherein determining if the transaction satisfies any condition of the one or more rules is performed using an Open Policy Agent.

3. The method of claim 1, wherein determining if the transaction satisfies any condition of the one or more rules is performed for all rules in parallel.

4. The method of claim 1, wherein determining if the transaction satisfies any condition of the one or more rules is performed in a non-procedural manner.

5. The method of claim 1, wherein the received data of the transaction comprises at least one of: a time of said transaction; a merchant ID; a category of merchant; a value of said transaction; a currency of said transaction; and a geographic location of said transaction.

6. The method of claim 1, wherein at least one defined rule is a default rule corresponding to a specified funding source to be used in the event that no condition of any other rule is satisfied by a transaction.

7. The method of claim 1, further comprising:
after one or more transactions:
deducing, by artificial intelligence, one or more transaction behaviors; and
recommending one or more rules based on the one or more deduced transaction behaviors.

8. A system comprising:
a memory; and
a processor configured to:
prior to any transaction:
store, in a database, details of an account;
associate a plurality of funding sources with said account;
define one or more rules, each rule corresponding to both a condition and a specified funding source from the plurality of associated funding sources;
assign a priority to each of said one or more rules;
store, in the database, said one or more rules and said priorities associated with said account;
and,
at a time of a transaction;
receive data of said transaction;
determine if said transaction satisfies any said condition of said one or more rules,
wherein, in the event of more than one satisfied condition, the highest priority rule among all satisfied conditions determines the funding source to be charged; and
charge the determined funding source,
wherein, in the event of determining that no condition is satisfied, charge any one of the plurality of associated funding sources.

9. The system of claim 8, wherein the processor is configured to execute an Open Policy Agent to determine if the transaction satisfies any condition of the one or more rules.

10. The system of claim 8, wherein the processor is configured to determine if the transaction satisfies any condition of the one or more rules for all rules in parallel.

11. The system of claim 8, wherein the processor is configured to determine if the transaction satisfies any condition of the one or more rules in a non-procedural manner.

12. The system of claim 8, wherein the received data of the transaction comprises at least one of: a time of said transaction; a merchant ID; a category of merchant; a value of said transaction; a currency of said transaction; and a geographic location of said transaction.

13. The system of claim 8, wherein at least one defined rule is a default rule corresponding to a specified funding source to be used in the event that no condition of any other rule is satisfied by a transaction.

14. The system of claim 8, wherein the processor is configured to:
after one or more transactions:
deduce, by executing an artificial intelligence, one or more transaction behaviors; and
recommend one or more rules based on the one or more deduced transaction behaviors.

15. A computer-implemented method of exchanging data tokens, the method comprising the steps of:
prior to a transfer of data tokens:
associating a plurality of token sources with an account;
defining one or more rules, each rule corresponding to a condition and a specified token source from the plurality of associated token sources;
assigning a priority to each of the one or more rules;
storing the one or more rules and the priorities against the account;
and,
at a time of a transfer of data tokens;
receiving data describing the transfer;
determining if the transfer satisfies any condition of the one or more rules, the token source from the satisfied rule being the determined token source unless more than one rule has a satisfied condition;
wherein, in the event of more than one rule with a satisfied condition, the highest priority rule among all satisfied conditions determines the token source to be used; and
using the determined token source,
wherein, in the event of determining that no condition is satisfied, using any one of the plurality of associated token sources.

16. The method of claim 15, wherein determining if the transfer satisfies any condition of the one or more rules is performed using an Open Policy Agent.

17. The method of claim 15, wherein determining if the transfer satisfies any condition of the one or more rules is performed in a non-procedural manner.

18. The method of claim 15, wherein the received data of the transfer comprises at least one of: a time of said transfer; a recipient ID; a number of data tokens; a type of data tokens; and a geographic location of said transfer.

19. The method of claim 15, wherein at least one defined rule is a default rule corresponding to a specified token source to be used in the event that no condition of any other rule is satisfied by a transfer.

20. The method of claim 15 further comprising:
after one or more transfers:
deducing, by artificial intelligence, one or more transfer behaviors; and
recommending one or more rules based on the one or more deduced transfer behaviors.
